(19) United States
(12) Patent Application Publication
(10) Pub. No.: US 2012/0278247 A1
(43) Pub. Date: Nov. 1, 2012

(54) VIRTUAL GOODS INCENTIVE SYSTEM

(76) Inventors: Michael Amar, Palo Alto, CA (US); Dimitri Ducourtieux, Feriey (FR); Suchit Dash, San Francisco, CA (US); Vida Ha, Mountain View, CA (US); Scott Silverman, Chatham, NJ (US); Rodolphe Courtier, Santa Clara, CA (US)

(21) Appl. No.: 13/548,273

(22) Filed: Jul. 13, 2012

Related U.S. Application Data
(63) Continuation-in-part of application No. 13/293,098, filed on Nov. 9, 2011.
(60) Provisional application No. 61/448,062, filed on Mar. 1, 2011.
(60) Provisional application No. 61/525,175, filed on Aug. 18, 2011.

(51) Int. Cl. G06Q 30/02

(52) U.S. Cl. 705/319

(57) ABSTRACT

An interface application enables a campaign manager to manage the transfer of virtual credits to a user upon completion of an action that benefits a provider of goods or services. The campaign manager provides a link to the provider of goods or services. When a user clicks through to this link, the interface application directs the user to perform the desired action. Upon completion of the action, the application deposits a credit to the user's virtual account. Because the virtual transaction is performed by the provided interface application, the logistics associated with launching and executing the campaign are low enough to facilitate hi-volume, low-cost incentive programs.

This application is a Continuation-In-Part of U.S. patent application Ser. No. 13/293,098, filed 9 Nov. 2011, and claims the benefit of U.S. Provisional Patent Applications 61/448,062, filed 1 Mar. 2011 and 61/525,175, filed 18 Aug. 2011.

### BACKGROUND AND SUMMARY OF THE INVENTION

This invention relates to the field of online marketing and sales, and in particular to a system and method for providing promotions and incentives for free “virtual goods” as an incentive for customer actions, such as making a purchase, subscribing to an email newsletter, joining a social networking group, writing a review, and so on.

The costs associated with acquiring a customer is often a significant overhead cost to a retailer. It is estimated that a typical program to acquire a customer, or reacquire a former customer, costs a retailer about $10 per acquired customer. Further, merely offering a cash rebate or discount does not necessarily distinguish the vendor from any other vendor offering the same product at the same discounted price, and in a competitive market, rarely does a single purchase at a discounted price instill a sense of customer loyalty.

It is also difficult for a typical retailer to create a list of potential customers that are likely to be interested in the particular products that the retailer offers. Retailers may be willing to provide an incentive to potential customers who subscribe to their mailings, or who are willing to provide personal data to facilitate targeted advertisements, and so on, but the logistics and costs associated with providing such incentives outside a current sales transaction often makes it infeasible to launch such incentives. Additionally, because such incentive programs are intended to be offered to a large number of people, the cost per respondent must be minimized, and minimized cash-based incentives, such as a rebate of 50 cents, is not likely to generate much interest. Additionally, the cost of delivering such a minimal rebate can be prohibitive due to transaction fees associated with the payment networks.

It would be advantageous to be able to offer an incentive to a potential customer that is perceived as something desirable, distinguishes the retailer from other retailers, and provides an opportunity to personalize subsequent interactions with the customer. It would also be advantageous if providing this incentive is less costly than a conventional cash-based incentive program. (For ease of reference, the term ‘cash-based’ is used herein to include any incentive program that provides a positive cash flow to the customer, including, for example, percentage or fixed discounts, cash rebates, reduced shipping costs, and so on.)

The inventors have recognized that social networking and, in particular, social gaming has become one of the largest growing, if not the largest growing field of endeavors in the past few years. It is estimated that over 290 million people monthly engage in social gaming today, with revenues amounting to over a billion dollars, and that these revenues will increase to over five billion dollars by 2015.

A substantial amount of the current and projected revenue is revenue generated by in-game transactions, wherein a user may purchase a “virtual” item that facilitates advancement in the game. For example, to advance to a next level in a game may consume hours of the user's time; alternatively, the user may purchase a virtual ‘credit’, and use this virtual credit to advance to the next level immediately. In like manner, a user may purchase a virtual tool or virtual weapon for use by the user's avatar to achieve particular tasks and goals, or a user may purchase a virtual animal or virtual seeds to facilitate growth or expansion of a virtual farm.

The inventors have also recognized that although there are millions of people engaged in social gaming, very few of these ‘gamers’ are willing to actually purchase the aforementioned virtual items for use in the games. A current estimate is that only about two to three percent of the current gamers are willing to purchase such virtual items.

The inventors believe that most gamers view virtual goods as desirable, but are reluctant to enact an actual cash transaction to purchase these virtual goods. This reluctance may be based on any number of factors, such as reluctance to disclose a credit card number within a social gaming environment, a reluctance to go through the bother of a transaction, a reluctance to pay actual cash for ‘make believe’ goods, and so on.

It would be advantageous to combine the need for novel incentive programs with the expected growth and increased involvement in social gaming. It would also be advantageous to provide a simple process for obtaining virtual goods without purchasing them directly.

The inventors have also recognized that providing an interaction with virtual environments and virtual accounts is not necessarily an activity that fits within the interests or skill-sets of a conventional provider. In like manner, increasing a user's balance in a virtual account is not necessarily an activity that the provider of the virtual account would want to be performed by any and all other providers. The risk of fraud and the overhead associated with maintaining actual accounts for receiving the deposits of actual funds corresponding to the purchase of virtual goods that are deposited to the various user virtual accounts, as well as the potential need to mitigate disputes between the user and the provider, may be a significant disincentive for the provider of the user virtual accounts. Conventionally, although the transfer of credits or goods between a gamer and the provider of the game is controlled by the provider of the game, the purchase of virtual credits using actual funds is generally solely controlled by the provider of the virtual account.

It would be advantageous to allow a provider of goods or services to offer virtual goods to a user in response to the user's completion of a desired action, without requiring the provider to interact directly with the provider of the virtual account.

These advantages, and others, can be realized by providing an interface application that enables a third party to manage the transfer of virtual credits to a user upon completion of an action that benefits a provider of goods or services. The third party, hereinafter the ‘campaign manager’, provides a link to the provider of goods or services; when a user clicks through to this link, the interface application directs the user to perform the desired action, then deposits a credit to the user's virtual account in response to the user's completion of the action. Initial tests have indicated that a substantial number of customers prefer receiving such virtual credits in lieu of a cash rebate or other cash-based discount, even when the actual cost associated with the virtual item is the same as, or lower than the amount of the cash-based discount. Because the entire transaction is accomplished via the provided interface application, the logistics associated with launching and executing the campaign are low enough to facilitate hi-volume, low-cost incentive programs.

### BRIEF DESCRIPTION OF THE DRAWINGS

The invention is explained in further detail, and by way of example, with reference to the accompanying drawings wherein:

FIG. 1 illustrates an example flow diagram for integrating a virtual goods incentive system into a provider's webpage.

FIG. 2 illustrates an example flow diagram for depositing virtual goods in a user's account in response to the user performing a desired action.

FIG. 3 illustrates an example flow diagram for a virtual goods incentive system using a third-party campaign manager.

FIGS. 4A-4E illustrate example screen shots for a virtual goods incentive system.

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

For the purposes of this disclosure, the term “provider” is used herein to identify any person or organization that is interested in attracting others (‘users’) to sample or use the material or service that they provide. In some cases the provider provides the material or service to the user at a cost to the user; in other cases, the provider provides the material or services without imposing a cost to the user, relying on other sources of income, such as advertisements, to generate revenue. Providers of materials or services at a cost to the user may include, for example, traditional retailers and other vendors, whereas providers of materials or services at no cost may include, for example, news service providers, social and business network providers, and so on. In general, the amount of revenue a provider receives is directly related to the number of users (customers, subscribers, etc.) of the provided material or service.

As is known in the art, providers of services often offer these services without cost to the user, but earn revenue based on advertisements and other sources. For example, a news provider, such as NBC, CBS, MSN, CNN, and so on, does not impose a cost on the users of this news service, yet are interested in attracting a larger viewership than other news providers for any of a variety of reasons.

For the purposes of this disclosure, the terms “virtual” and “actual” are used herein to distinguish elements that exist only within an artificial, or software, environment from those that exist in reality. A virtual cow, for example, is a simulacrum in a virtual environment that performs in the virtual environment in a manner similar to an actual cow on an actual farm. Virtual cash, in like manner, is used in a virtual environment in a manner similar to actual cash in the physical world.

Obviously, because virtual goods do not represent actual assets, there is no real ‘cost’ associated with the virtual goods, other than the nominal cost defined by the virtual environment provider for obtaining such virtual goods. Accordingly, the nominally defined cost to provide a virtual cow, for example, will be substantially less than the actual cost to provide a live cow. In like manner, a nominally defined cost of providing credits that can be used to save hours of gaming time achieving a goal will be substantially less than an actual cost associated with the gamer's time.

The invention is premised on the observation that social gamers perceive virtual goods, such as Facebook credits, Cityville cash, Farmville animals, and the like, as being valuable, and that if a simple and straightforward interface were provided to easily obtain such virtual goods, more gamers would begin using virtual goods to enhance their gaming enjoyment.

This invention is also premised on the observation that offering virtual goods, instead of actual goods, as an incentive by a provider will distinguish this provider from other providers, and if the overall value associated with obtaining the virtual goods is perceived by the customer as being more desirable than actual goods having a higher cost to the provider, the cost of providing the virtual goods incentive will be less.

A further advantage of coupling an incentive program to social gaming is that the gaming environment typically includes a profile of each gamer, and this profile may be used to facilitate subsequent contacts with the gamer, encouraging further interactions with the provider.

As noted above, creating an application that issues virtual goods in return for the user performing a desired action, such as making a purchase, ‘friending’ the provider, and so on, is generally not in the skill set of a typical provider of goods or services. And, the provider of the virtual accounts for receiving these virtual goods may restrict access to its accounts to particular clients who have provided assurance that the process will be well regulated.

In accordance with an aspect of this invention, a third party ‘campaign manager’ is responsible for the issuance of virtual goods to a user's virtual account and for paying the corresponding actual cost of these virtual goods to the provider of the virtual accounts. In a Facebook credit incentive program, for example, the campaign manager is authorized by Facebook to effect deposits to users' virtual accounts, and is required to pay Facebook a corresponding actual fee for issuance of these virtual deposits.

The financial arrangements between the provider of the virtual goods and the account manager may vary. In some situations, the campaign manager may be required to purchase the virtual goods from the provider of the virtual accounts before depositing these virtual goods into the users' accounts; in other situations, the campaign manager may establish a credit account with the provider of the virtual accounts. Similarly, in some situations, the provider of the virtual accounts may offer the virtual goods at a purchase price that is below the nominal actual price for the virtual goods. For example, the nominal cost of one Facebook credit is ten cents, and Facebook may offer to sell these credits to a ‘volume buyer’ at five cents each.

In addition to managing the granting of virtual goods in return for the user's performance of a desired action, the campaign manager may also provide the interface between the user and the provider of goods or services for effecting such grants, thereby eliminating the need for the provider of goods or services to develop this interface.

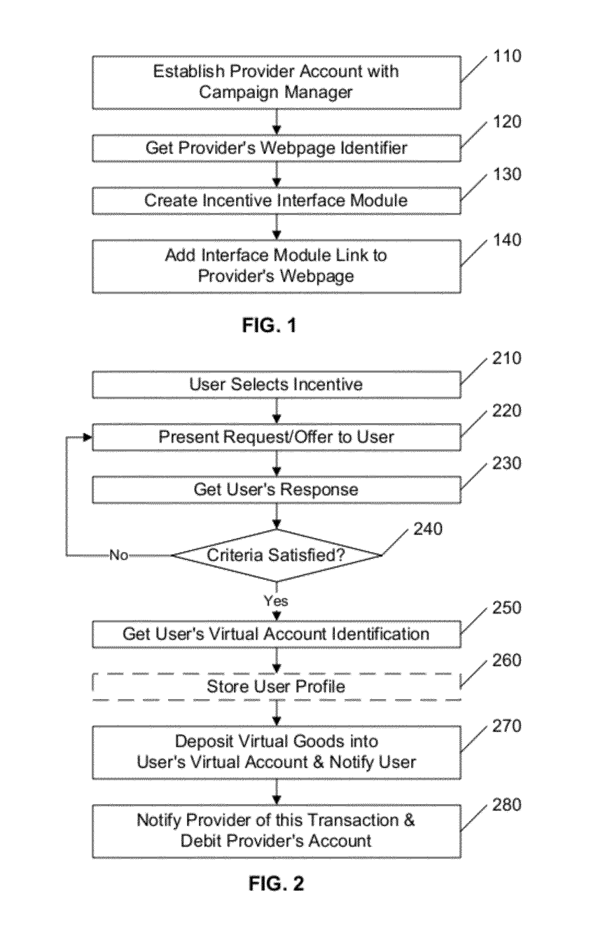

FIG. 1 illustrates an example flow diagram for providing an integrated system for implementing a virtual goods incentive program, and FIG. 2 illustrates an example flow diagram of the operation of the integrated system for issuing virtual goods in response to a user's performance of a desired action.

At 110, the campaign manager negotiates an agreement with the provider of goods or services for managing a virtual goods incentive program. The agreement will generally include a description of the desired user action and the amount and type of virtual goods to be issued to the user upon completion of the desired action, as well as the parameters associated with the incentive program including, for example, a duration limit, a cost limit, and so on. In some cases there may be limits set for each user, as well as limits set for the entire program.

In a preferred embodiment of this invention, the campaign manager may also agree to provide the interface between the user and the provider of the goods and services for offering the incentive; alternatively, the campaign manager may merely provide example program code for creating such an interface, and allow the provider to customize the actual embodiment of the interface, and to transfer control to the campaign manager's server when the user agrees to participate in the incentive program. The example of FIG. 1 assumes that the campaign manager is providing the interface between the user and the provider of the goods and services.

At 120, the campaign manager receives an identification of the webpage of the provider of goods or services at which the incentive program is to be implemented. The campaign manager uses this identification to create an interface application, at 130. As noted above, in some embodiments, the provider of goods or services may create the interface application. The interface application is added to the provider's webpage, at 140. In most cases the provider will manage the actual installation of the interface application in the provider's webpage.

Preferably, the interface application will present the incentive offer to the user, and will receive the user's response (if any) to this incentive offer. This interface application will also be configured to transfer subsequent operations to a server that is operated by the campaign manager for processing the user's response and issuing the virtual goods upon the user's completion of the desired action.

FIG. 2 illustrates the user's interaction with the virtual goods incentive system after the interface application is added to the provider's webpage.

At 210, the user selects the incentive at the provider's webpage. At 220, the request for a desired user action is presented, with an offer of virtual goods in return for the user's performance of this action. The user responds to the offer, at 230, and if the user's actions satisfy the criteria for issuing the virtual goods, at 240, the system proceeds to obtain the information necessary to effect the deposit of the virtual goods into the user's virtual account, at 250. Note that, depending upon the criteria for completing the desired action, the user's response, at 230, may involve a series of transactions, and may not be performed during one contiguous session. For example, if the incentive program is targeted to obtain e-mail addresses of associates of the user, the user may be required to enter each e-mail address individually, while the system may be configured to verify that each e-mail address is valid before issuing the virtual goods.

In some embodiments, some or all of steps 210-240 may be combined, and in some embodiments, the system may automatically perform the desired action in response to the user's selection of the incentive. For example, Facebook credits may be offered in return for a user “Like”-ing the provider of goods or services. The provider's webpage may provide a “Like” button, and when the user clicks on the “Like” button, the system communicates the “Like” to Facebook, then proceeds to initiate the depositing of the Facebook credits to the user's virtual account.

In other embodiments, the incentive program may offer virtual goods in return for the purchase of an item from the provider, and the verification process at 240 may include verifying with the provider of the goods or services that the purchase has, in fact, been made. In some embodiments, the verification process may be performed in parallel with the remainder of the depositing process, and the deposit may be ‘pending’ until the verification process is completed.

To initiate the deposit process, the system queries the user to obtain the information necessary to effect the transfer of the virtual goods to the user's virtual account, at 250. The particular procedure for accessing the user's virtual account and provide a deposit will be dependent upon the particular virtual environment associated with the virtual account. Most virtual environments allow users to ‘gift’ credits from one user to another, and, as noted above, in a preferred embodiment, the campaign manager will have established a relationship with the provider of the virtual environment to facilitate such transfers.

In many cases, the incentive program is targeted to identify potential new customers for the provider of the goods or services. Accordingly, the system may be configured to obtain personal information from each user, such as the user's e-mail address and demographic data.

In the example of a deposit to a Facebook account, in addition to requesting permission to post to the user's Facebook wall in order to make the actual deposit, the system may also request permission to obtain the user's e-mail address and to access the user's profile information. The e-mail address is nominally requested for sending a confirmation e-mail regarding the deposit of the virtual goods, but also serves to allow the provider of goods or services to send targeted e-mails to the user with other offers and incentives and to validate the email inputted to ensure quality leads & information about the customer. The user's profile information may be stored, at 260, and subsequently used to determine the user's preferences and demographics, to facilitate selective targeting and personalization.

For example, the user's profile information may indicate that the user is a frequent Farmville gamer, and a targeted incentive could include virtual farm animals; in like manner, if the user is not a Farmville gamer, Farmville-based virtual objects would not be offered, or an offer to join Farmville might be offered. The profile information may also be used to identify actual objects that the user may have an interest in, based on the user's gender, age, expressed interests, and so on. For example, if the user indicates that he/she is an avid runner, offers for high-performance sneakers may be appropriate.

At 270, the deposit of virtual goods into the user's virtual account is made, and the user is notified of the virtual goods deposit. The user may also be provided the opportunity to publish an opinion of the transaction; in a preferred embodiment, this publication may also be sent to the user's friends on Facebook or other social network. Optionally, the user's agreement to publish the opinion may also result in the deposit of additional virtual objects into the user's virtual account.

At 280, the campaign manager notifies the provider of the goods or services of the transaction, and debits that provider's actual account accordingly, based on the agreed upon actual-virtual exchange rate. Depending upon the agreement between the provider of goods or services and the campaign manager, the collected user profile may also be included in this notification report.

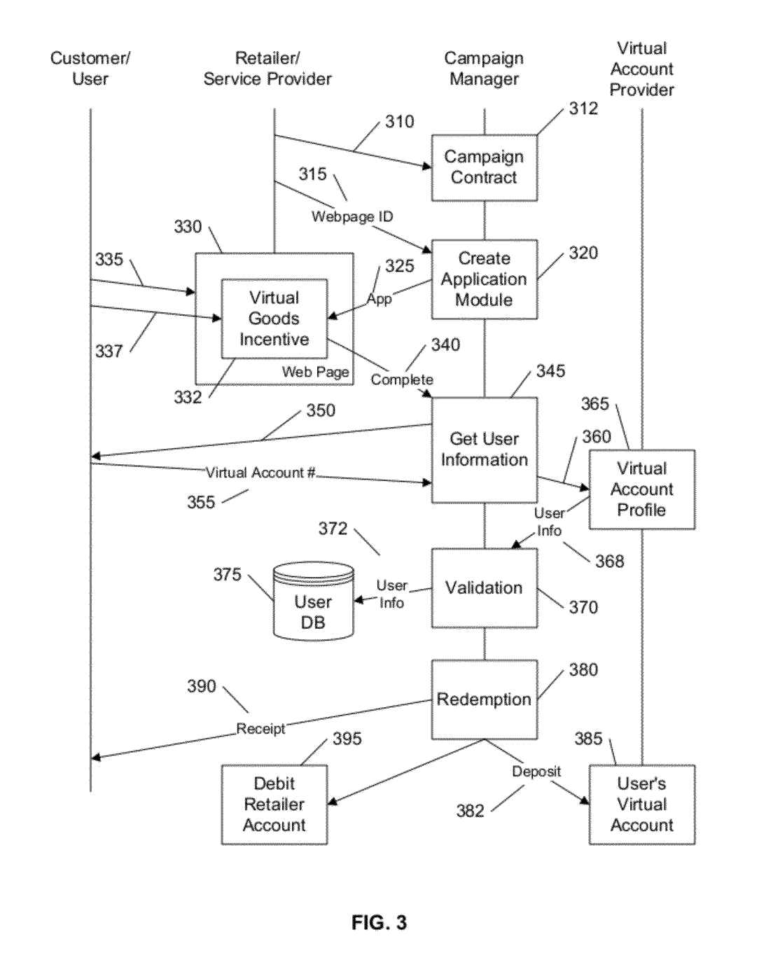

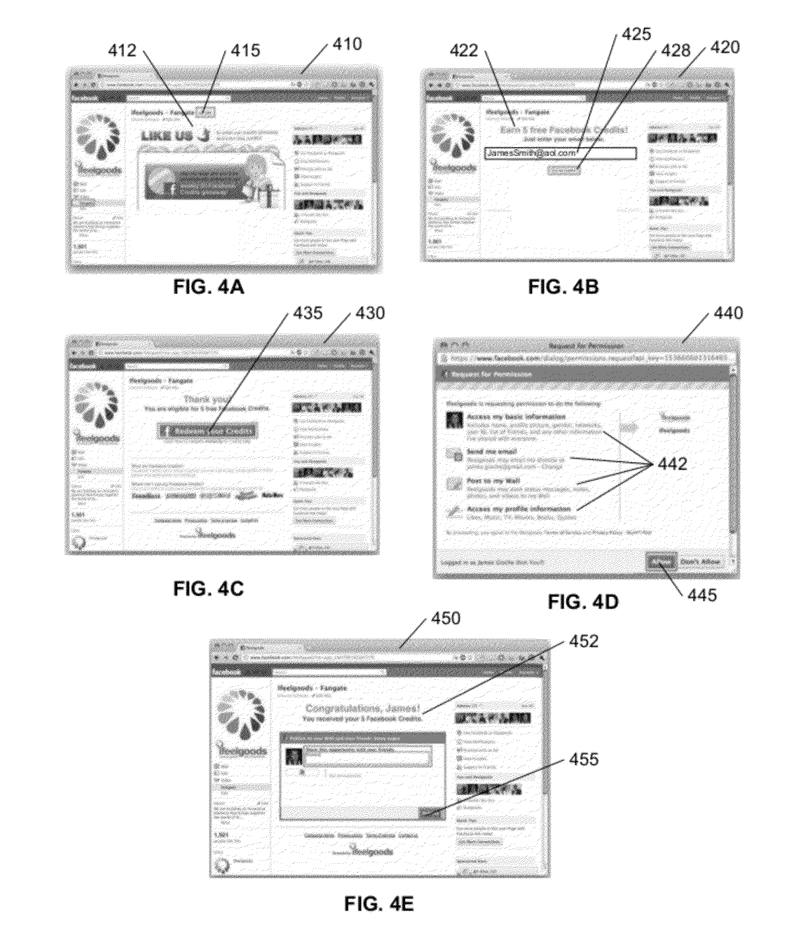

FIG. 3 illustrates the interaction flow among the user, the provider of goods or services, the campaign manager, and the provider of the virtual environment, or the vendor of the virtual goods. FIG. 4 illustrates example screen shots during this interaction. Reference numerals beginning with the digit “3” refer to FIG. 3; beginning digit “4” refers to FIG. 4.

The incentive program, or campaign, is initiated by communications 310 between the provider of goods or services and the campaign manager, resulting in a campaign contract, or agreement 312. This agreement defines the responsibilities of each party, and includes details such as the duration of the campaign, individual and cumulative limits to the amount of virtual goods issued, and so on.

Assuming that the agreement 312 calls for the campaign manager to provide the interface application that will manage the presentation and execution of the incentive program, the provider of goods or services informs the campaign manager of the webpage 315 to which the incentive program is to be attached. The campaign manager creates the interface application, at 320, and communicates the module 325 to the provider of goods or services for inclusion in the provider's webpage 330. The interface application 325 is configured to present a notification of the incentive 332, and to manage the interactions with the user when the user selects the incentive. In this example, the user interacts 335 with the provider's web page, and eventually selects 337 the virtual goods incentive 332.

In the example of FIG. 4A, a virtual goods incentive is provided to encourage users to “Like” the provider of goods or services. The Like button 415 is a feature of social networking service Facebook, where users can Like content such as status updates, comments, photos, links shared by friends, and advertisements. When a user clicks the Like button, the content appears in his/her friends' “News Feeds”. Facebook describes Liking as a way for users to give positive feedback and connect with things they care about. A “Like Box” also allows Facebook page owners to see how many users and which of their friends like the page.

The incentive 412 is displayed on the provider's web page 410 as a request for the user to Like the provider, and the user is provided the Like button 415 to effect this Liking of the provider.

When the user completes the requested task, a notification of this completion 340 is communicated to the campaign manager's server for further processing 345 by the campaign manager's application. In some embodiments, the mere selection 337 of the incentive is sufficient to signal completion of the desired action; in other embodiments, other tasks may need to be performed before the completion signal 340 is communicated to the campaign manager. In some embodiments, the determination of whether the action has been completed is determined by the campaign manager's application.

In response to this completion signal 340, the campaign manager proceeds to obtain information from the user. In FIG. 4B, the campaign manager provides the webpage 420 that acknowledges that the user is entitled to earn five Facebook credits 422 for having Liked the provider. In this example, the campaign manager requests the user's e-mail address 425 to initiate the redemption process. When the user signals completion 428, another page 430 is displayed, requesting confirmation 435 that the user desires these Facebook credits.

Because the user in the example of FIG. 4 is operating within Facebook when the Like button is displayed, the user's Facebook identifier is available to the campaign manager; in other embodiments, the campaign manager may specifically request 350 the user's virtual account identifier 355, as illustrated in FIG. 3.

Because most incentive programs are targeted to obtain information about the users that have performed the desired action, the campaign manager uses the virtual account identifier 355 to request 360 this information 368 from the provider of the virtual account. Most, if not all, providers of virtual accounts maintain a database 365 of user profiles, and provide means for accessing this information. Depending upon the policies and practices of the virtual account provider, access to this information 368 may be dependent upon receiving explicit permissions from the user.

In the example of FIG. 4D, the campaign manager requires that the user to grant permission to four features 442: permission to access the user's basic information (e.g. name, gender, friends, etc.); permission to send e-mails to the user; permission to post to the user's Facebook wall; and permission to access the user's complete profile (e.g. Likes, preferences for music, movies, etc.). If the user grants 445 these permissions, the redemption is executed; otherwise, the user can choose not to grant the permissions and forego the redemption.

As illustrated in FIG. 3, the campaign manager may optionally validate the information 368 associated with the user's virtual account. For example, if the user's profile is virtually empty, the campaign manager may conclude that this virtual account is a ‘dummy’ account, and not the account that the user uses for social networking. Copending U.S. patent application Ser. No. 13/436,871, “FRAUD DETECTION SYSTEM BASED ON SOCIAL DATA”, filed 31 Mar. 2012 for Vida Ha and Nicholas Grenie, discloses a variety of techniques for determining whether the social data associated with a virtual account suggests that the information is bogus, and is incorporated by reference herein.

If the user's profile data 368 is determined to be valid, or if the optional validation 370 is not performed, some or all 372 of this information may be stored in a user database that is maintained by either the campaign manager or the provider of goods and services, depending upon the terms of the agreement 312. In some embodiments, the campaign manager may provide this user information at an additional cost, and in some embodiments, the campaign manager may be authorized to provide this information 372 to parties other than the provider of goods and services for this incentive program.

At 380, the virtual goods redemption is performed by depositing 382 the virtual goods that were offered in return for the user's action into the user's virtual account 385. As noted above, the means for effecting this deposit 382 into the user's account 385 will be dependent upon the provider of the virtual account and/or the issuer of the virtual goods. Some providers of virtual accounts may allow a purchaser of virtual goods to deposit the virtual goods into any virtual account; other providers may restrict the number of eligible depositors to a select few, to reduce the potential for fraudulent deposits or other unwanted actions.

Upon completion of the deposit, the account of the provider of goods or services is debited for the actual cost of the virtual goods that were deposited. The aforementioned agreement 312 will generally include the costs (in actual currency) to the provider of goods or services for the virtual goods that are supplied by the campaign manager, which will generally be different from (higher) than the costs of the virtual goods supplied by the provider of the virtual account, or the vendor of the virtual goods, to the campaign manager.

Thereafter, the user is notified 390 that the deposit 382 has been made to the user's virtual account 385. FIG. 4E illustrates a web-page 450 with such a notification 452.

In a preferred embodiment of this invention, the user is also provided an opportunity 455 to publish comments on the incentive program, the provider of goods or services, and so on. These comments will be generally be communicated by Facebook to each of the user's friends.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any feasible combination thereof

f) hardware portions may include a processor, and software portions may be stored on a non-transitory computer-readable medium, and may be configured to cause the processor to perform some or all of the functions of one or more of the disclosed elements;

g) hardware portions may be comprised of one or both of analog and digital portions;

h) any of the disclosed devices or portions thereof may be combined together or separated into further portions unless specifically stated otherwise;

i) no specific sequence of acts is intended to be required unless specifically indicated; and

j) the term “plurality of” an element includes two or more of the claimed element, and does not imply any particular range of number of elements; that is, a plurality of elements can be as few as two elements, and can include an immeasurable number of elements.

We claim:

1. A method comprising:
providing an interface application for a web-page of a provider of material or services, the interface application being configured to present a request from the provider to a user, the request including an offer for receiving virtual goods in return for responding to the request,
receiving a user response to the request,
providing a web-page of a campaign manager in response to receiving the user response,
collecting an identifier of the user, including a virtual account associated with the user,
transferring the virtual goods to the virtual account, and
debiting an actual account associated with the provider.

2. The method of claim 1, wherein the virtual account is a Facebook account.

3. The method of claim 1, wherein the virtual goods include one or more Facebook credits.

4. The method of claim 1, wherein the request includes asking the user to “Like” the provider.

5. The method of claim 1, including storing a profile associated with the user.

6. A non-transitory computer readable medium that includes code that, when executed by a processor, causes the processor to:
present a request from the provider to a user, on a web-page of the provider, the request including an offer for receiving virtual goods in return for responding to the request,
receive a user response to the request,
cause a web-page of a campaign manager to be presented to the user in response to receiving the user response, and
transfer control to a second processor that:
collects an identifier of the user, including a virtual account associated with the user,
transfers the virtual goods to the virtual account, and
debits an actual account associated with the provider.

7. The medium of claim 6, wherein the virtual account is a Facebook account.

8. The medium of claim 6, wherein the virtual goods include one or more Facebook credits.

9. The medium of claim 6, wherein the request includes asking the user to “Like” the provider.

10. The medium of claim 6, wherein the second processor stores a profile associated with the user.

11. A method comprising:
receiving an interface application from a campaign manager, the interface application being configured to present a request from a provider to a user, the request including an offer for receiving virtual goods in return for responding to the request,
installing the interface application on a web-page of the provider,
receiving a user response to the request,
causing a web-page of the campaign manager to be presented to the user in response to receiving the user response,
enabling the campaign manager to:
transfer the virtual goods to a virtual account associated with the user, and
debit an actual account associated with the provider based on the transfer of the virtual goods.

12. The method of claim 11, wherein the virtual account is a Facebook account.

13. The method of claim 11, wherein the virtual goods include one or more Facebook credits.

14. The method of claim 11, wherein the request includes asking the user to “Like” the provider.

15. The method of claim 11, including storing a profile associated with the user.

16. A non-transitory computer readable medium that includes code that, when executed by a processor, causes the processor to:
receive a user response to a request that was presented to a user from a provider, on a web-page of the provider, the request including an offer for receiving virtual goods in return for responding to the request,
present a web-page of a campaign manager to the user in response to receiving the user response,
collect an identifier of the user, including a virtual account associated with the user,
transfer the virtual goods to the virtual account, and
debit an actual account associated with the provider.

17. The medium of claim 16, wherein the virtual account is a Facebook account.

18. The medium of claim 16, wherein the virtual goods include one or more Facebook credits.

19. The medium of claim 16, wherein the request includes asking the user to “Like” the provider.

20. The medium of claim 16, wherein the code causes the processor to store a profile associated with the user.
